(19) United States
(12) Patent Application Publication
(10) Pub. No.: US 2022/0198573 A1
(43) Pub. Date: Jun. 23, 2022

(54) SYSTEMS AND METHODS TO PROVIDE DENTAL CARE SERVICES

(71) Applicant: WellifyMe, Inc., Bend, OR (US)

(72) Inventors: Michael Austin Brown, Orlando, FL (US); Matthew Curran, Portland, OR (US); Brenton Hendrickson, Franklin, TN (US); Daniel T. Marut, Bend, OR (US); Samantha L. Marut, Bend, OR (US); Philip M. Mattingly, Brentwood, TN (US)

(73) Assignee: WellifyMe, Inc., Bend, OR (US)

(21) Appl. No.: 17/644,616

(22) Filed: Dec. 16, 2021

Related U.S. Application Data
(60) Provisional application No. 63/127,260, filed on Dec. 18, 2020.

(51) Int. Cl. G06Q 40/08

(52) U.S. Cl. CPC G06Q 40/08

(57) ABSTRACT

Disclosed is a method for providing dental care benefits to a beneficiary through a matching tool that displays a list of dental services providers in response to a search by the beneficiary. The results are displayed according to a percent match score, which ranks the displayed providers according to user search criteria. Also disclosed is a system for providing dental services benefits through a computer program or application. The application includes a graphical user interface to facilitate interaction with a user, and performs a search for dental services providers according to a set of user criteria. The application accesses a plurality of entries on providers, the entries including the provider's name, location, offered dental services, pricing, hours, and contact information. The application also includes an administration module that performs a registration function, an employer account function, and an employee account function.

### CROSS-REFERENCE TO RELATED APPLICATIONS

This application claims priority to U.S. Provisional Application No. 63/127,260, filed Dec. 18, 2020, which is hereby incorporated by reference herein in its entirety.

### BACKGROUND OF THE INVENTION

### Field of the Invention

Embodiments of the present invention relate, in general, to systems and methods for administering dental care benefit programs and coordinating dental care for patients.

### Relevant Background

In the disclosed invention, comprehensive systems for matching dental care providers with patients, and administering employer-based systems of payment for dental services are described.

Current systems for providing dental services are fragmented and piecemeal: dentist offices, benefits brokers, employers, and patients all interact independently. Such fragmentation results in the wastage of approximately 40% of dollars spent annually on employer-provided dental insurance, and the inability to efficiently match patients with dental care providers. An integrated dental care provision system as disclosed herein will save money for employers, both in the outlay for their employees' dental care, but also in reduced administrative costs. Employers will also have more insight into the use of funds allocated for employee dental care. Current systems provide beneficiaries with less freedom to choose their preferred dental services provider, and less information necessary to efficiently make such choices. Like employers, beneficiaries under current systems have less transparency about the overall cost of dental services, as well as the out-of-pocket cost allocations for dental procedures. Beneficiaries also do not currently have uniform access to solutions for paying large dental care costs over time. Dental care providers are disadvantaged by current systems, which do not optimize outreach to potential customers or help drive business to their practices. Finally, current systems do not provide efficient means of payment and reconciliation between dentists and payors.

Therefore, it is apparent that a need exists for dental services provision systems that more effectively match patients with dental care providers and more efficiently provide dental services through employer-based dental care plans. These and other deficiencies of the prior art are addressed by one or more embodiments of the disclosed invention. Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out hereafter.

### BRIEF DESCRIPTION OF THE DRAWINGS

Features and objects of the present invention and the manner of attaining them will become more apparent, and the invention itself will be best understood, by reference to the following description of one or more embodiments taken in conjunction with the accompanying drawings and figures imbedded in the text below and attached following this description.

FIGS. 1A and 1B depict a high-level flow chart featuring aspects of the disclosed invention;

FIG. 2 depicts a portion of the high-level flow chart of FIGS. 1A and 1B featuring aspects of the disclosed invention;

FIG. 3 depicts a portion of the high-level flow chart of FIGS. 1A and 1B featuring aspects of the disclosed invention;

FIG. 4 depicts a portion of the high-level flow chart of FIGS. 1A and 1B featuring aspects of the disclosed invention;

FIG. 5 depicts a graphical user interface included in embodiments of the disclosed invention;

FIG. 6 depicts a graphical user interface included in embodiments of the disclosed invention;

FIGS. 7A, 7B, and 7C depict graphical user interfaces included in embodiments of the disclosed invention;

FIG. 8 depicts a graphical user interface included in embodiments of the disclosed invention; and

FIG. 9 depicts a graphical user interface included in embodiments of the disclosed invention.

As used herein, employee means an individual eligible to receive dental care benefits through an employer. An employee may be a legally-defined employee, partner, independent contractor, or other similar professional relationship, as long as the individual is offered dental care benefits by an employer.

As used herein, an employer is a person or corporate entity that provides dental care benefits to individuals in a professional relationship with the employer.

As used herein, a beneficiary, enrollee, or patient is an employee, their dependent(s), family member(s), or other person(s) that receive dental care benefits through an employer.

As used herein, provider or practitioner means a dentist or dental practice that participates in a dental benefits system, wherein a dentist is an individual health care practitioner that treats human teeth, and a dental practice is a business comprising one or more dentists.

As used herein, application means a program run on a computing device. Application also includes a website-based program run through an internet browser.

### DETAILED DESCRIPTION OF THE INVENTION

The detailed description of the disclosed invention will be primarily, but not entirely, limited to systems and methods for providing comprehensive dental care benefit administration, including matching dental care providers with patients, and managing payment systems for dental care services as organized through employers of the patients.

Embodiments of the present invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the disclosed invention are provided for illustration purpose only and not for the purpose of limiting the invention as defined by the appended claims and their equivalents.

Like numbers refer to like elements throughout. In the figures, the sizes of certain lines, layers, components, elements, or features may be exaggerated for clarity.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a nonexclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be also understood that when an element is referred to as being “on,” “attached” to, “connected” to, “coupled” with, “contacting”, “mounted,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

Included in the description are flowcharts depicting examples of the methodology which may be used to provide patient matching with dentists or dental practices. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve the manipulation of information elements. Typically, but not necessarily, such elements may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” “words”, or the like. These specific words, however, are merely convenient labels and are to be associated with appropriate information elements.

Unless specifically stated otherwise, discussions herein using words such as “processing,” “computing,” “calculating,” “determining,” “presenting,” “displaying,” or the like may refer to actions or processes of a machine (e.g., a computer, such as a smartphone, tablet, laptop, desktop, or other device) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

### Dental Services Provision System

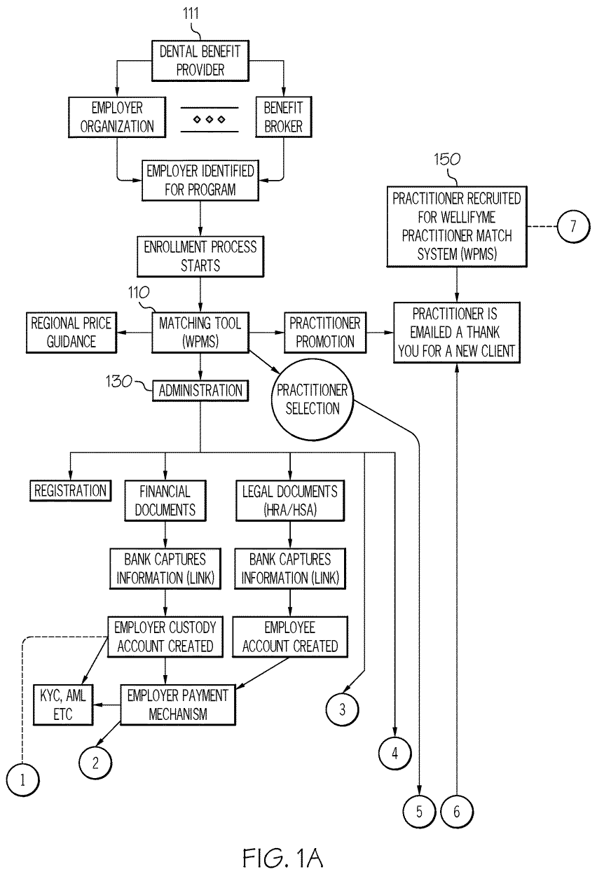

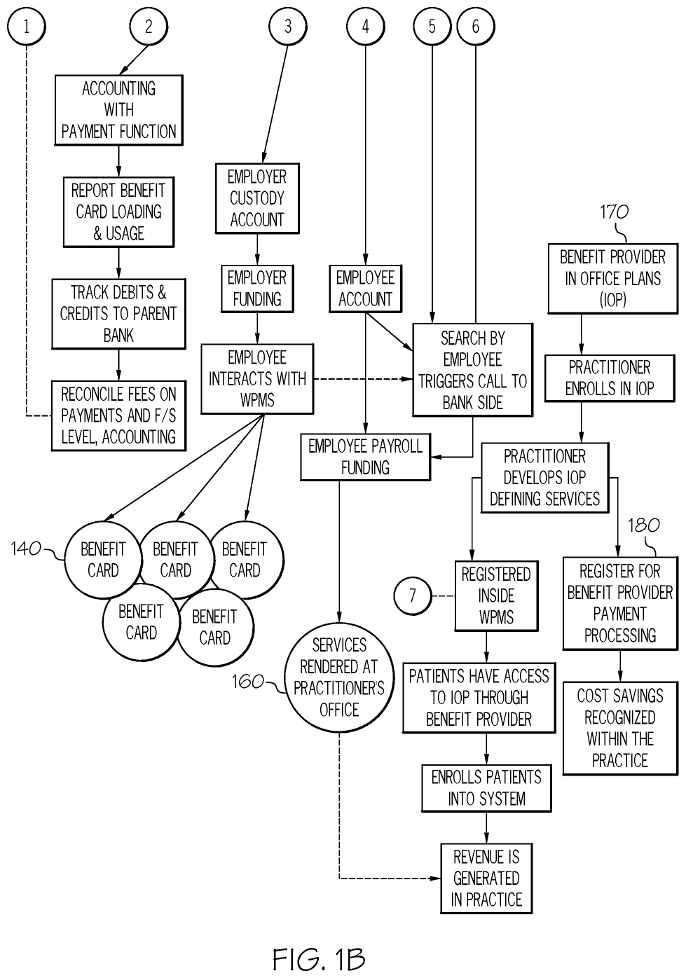

Embodiments of the disclosed invention include comprehensive systems for administering dental care benefits. Such systems comprise several integrated components. With reference to FIGS. 1A and 1B, several such components are depicted. Each component is developed considering the experience of the end-user, whether that user is an employer, employee, or care provider, and are intended to promote efficiency, ease of use, and maximum benefit to all parties.

The first such component of the disclosed system is a Matching Tool or WPMS 110, which allows beneficiaries to match with dental services providers. The Matching Tool comprises a dynamic matching algorithm that accounts for pricing, customer reviews of a dentist or dental practice, location of a dental practice, hours of operation, types of services provided, and dentist or appointment availability. The weight provided to each category may be set by algorithm, adjusted by a user, adjusted by an administrator, or may be customized for a particular geographic area, market, employer, or plan.

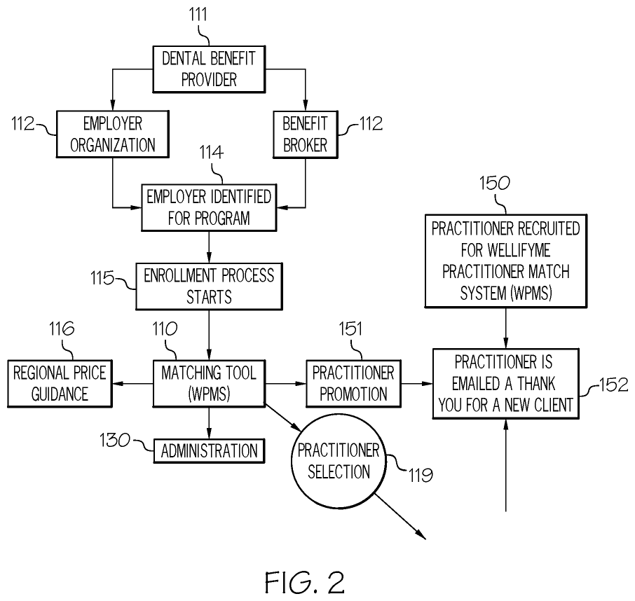

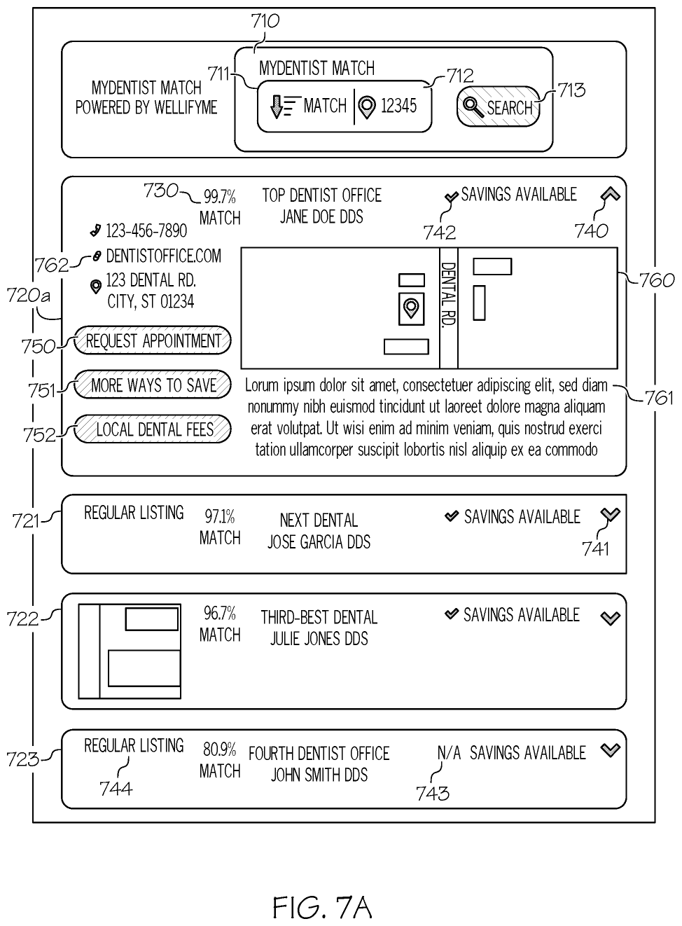

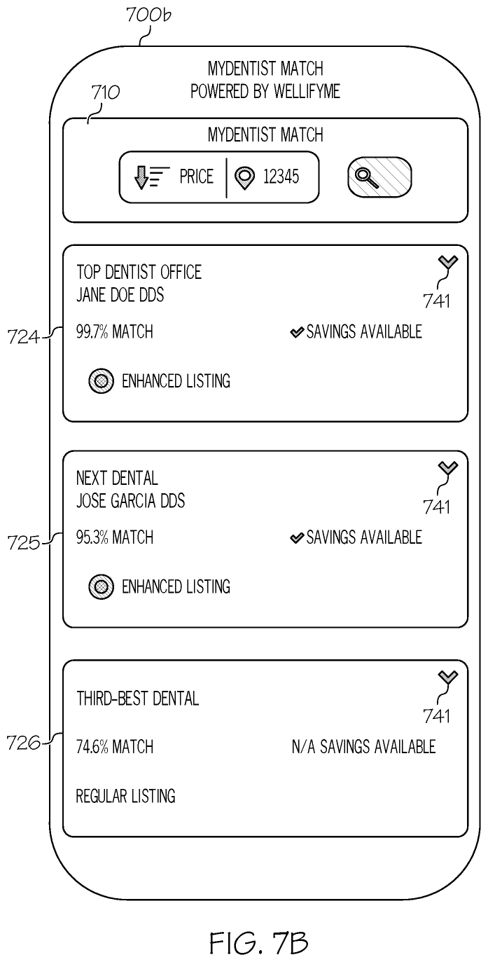

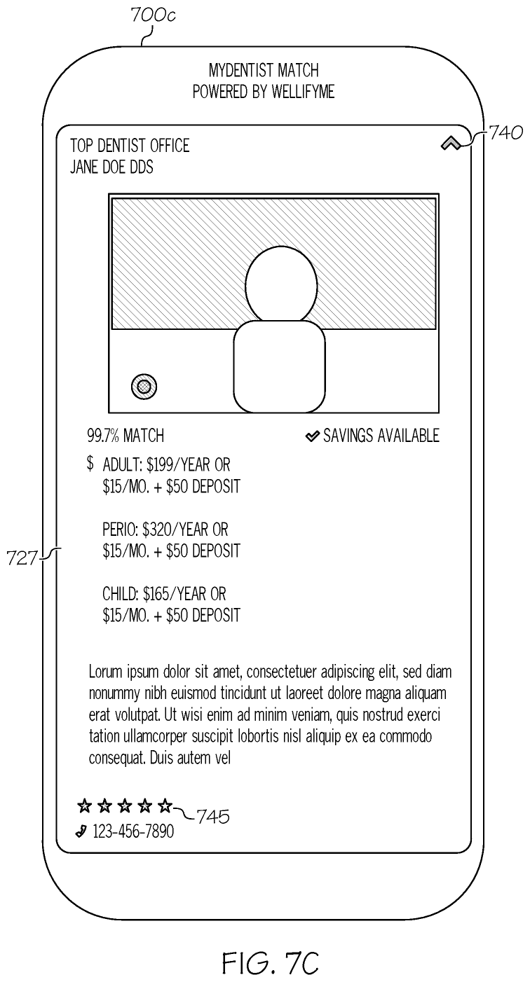

With reference to FIG. 2, which depicts a portion of the flow chart from FIGS. 1A and 1B, inputs and outputs for the Matching Tool 110 are shown. The dental benefit provider 111, e.g., WellifyME, Inc., operating the disclosed dental care benefit delivery system works with benefit brokers 113, and in some cases directly approaches prospective employer candidates 112, to identify employers 114 to enroll in the dental care benefit program. Employers 114 then enroll themselves and their employees in the system through an enrollment process 115. The enrollment process includes receiving contact information for individual employees and their dependents, as well as relevant personal information, such as medical and dental records, etc. Once enrolled, employees and their dependents become enrollees or beneficiaries in the system, and are provided access to the Matching Tool 110. The Matching Tool uses information about the enrollee, including the enrollee's address, demographics, medical and dental information, the dental services the enrollee requires, and other relevant information as inputs for its matching algorithm. In some embodiments, the Matching Tool 110 receives regional price guidance 116, which includes average prices for specific dental services in the local geographic area, or in some embodiments, regional price guidance 116 is an assessment of relevant factors affecting the price of dental services for a given geographic area, e.g., local cost of living. In other embodiments, regional price guidance 116 is not factored into the Matching Tool algorithm, but is accessible as additional information accessible within Matching Tool search results, see FIG. 7A, 752.

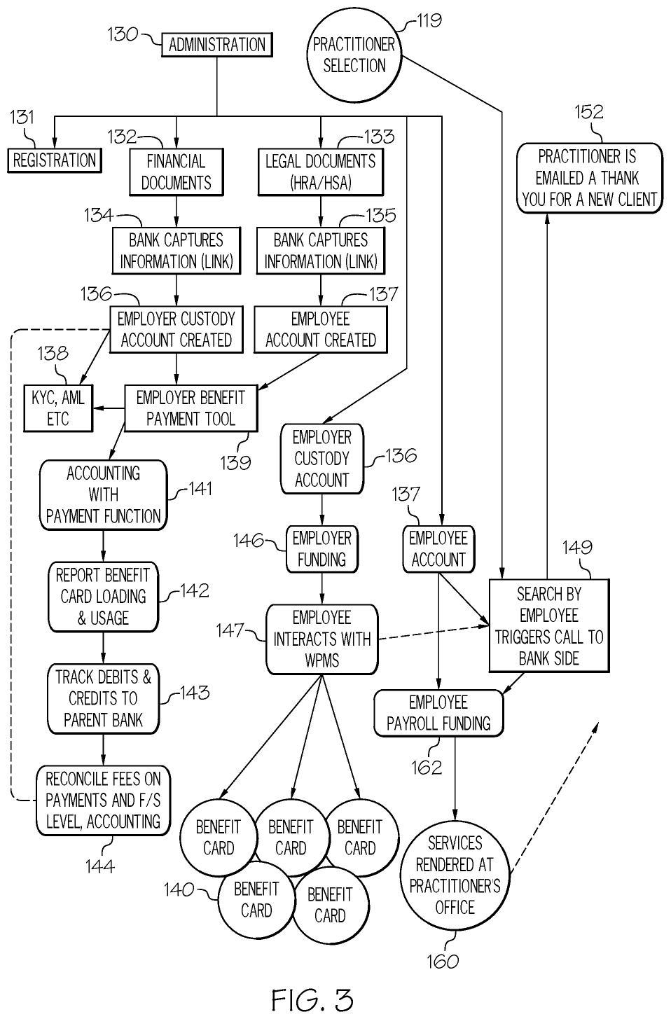

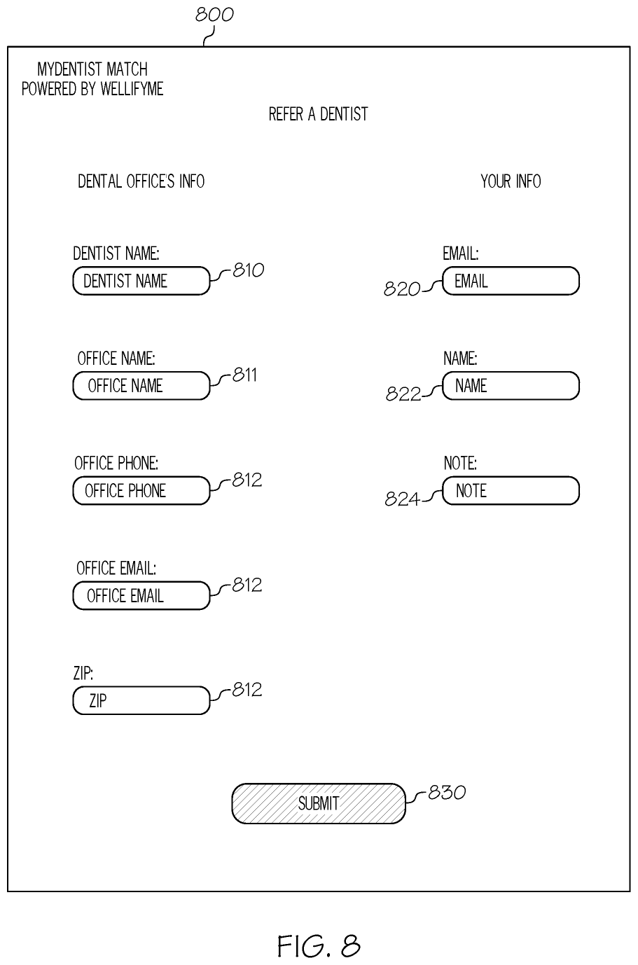

The Matching Tool 110 also accounts for the dental care landscape for the enrollee, including information about dentists or dental practices in the enrollee's geographic area, such as their office location relative to the enrollee's address, types of dental services offered, pricing, customer ratings, hours of operation and availability. Like employers and their employees, practitioners are also recruited to participate in the system 150. One means of recruitment is by creating a provisional or unclaimed profile for a dentist or dental practice in the system. The unclaimed profile includes contact information for administrators of the system so that practitioners can claim their profile and participate in the system. Other recruitment methods include direct marketing approaches to dentists, enrollee requests, employer requests, broker requests, and other suitable means. In some embodiments, the system includes a referral form to allow users to refer a dentist to the system, see FIG. 8. Practitioners may pay an advertising fee or may otherwise qualify for a practitioner promotion 151, wherein the dentist receives a preferential display location in the search results displayed for the enrollee. When the practitioner recruits a new patient through the system, the system sends a thank you message 152 to the practitioner to promote the benefits of the system to practitioners. This message may be generated by an enrollee's use of the Matching Tool, see FIG. 3, 149. The Matching Tool 110 may also generate recommended promotional listing(s) 151 for certain practitioners that are displayed along with organic search results. In some embodiments, a promotional listing 151 includes pricing discounts, e.g., a new patient discount, a senior discount, or an open-chair discount. Such promotional pricing may be applied dynamically in real time to lower prices. For example, if a dentist had several open appointment slots, the dentist could promote an open chair discount on its search results that would improve the dentist's % Match score when a beneficiary searched using the Matching Tool. Once the enrollee makes a practitioner selection 119, i.e., chooses a dentist or dental practice, the enrollee and dentist are matched by the system. The enrollee is then referred by the Matching Tool 110 to the system's administration module 130.

With reference to FIG. 3, which depicts a portion of the flow chart from FIGS. 1A and 1B, the administration function 130 of the system is shown. The administration function 130 generally handles account management and payment for dental services. Enrollment of employees/beneficiaries, employers and practitioners into the system is accomplished by a registration module 131, which stores relevant information about each category of system participant and allows such information to be retrieved and used as required. Sensitive information, such as Protected Health Information (PHI), financial information, and other confidential information, is stored under encryption and controlled access protocols appropriate to the type of information. Each employer completes financial documents 132 that are shared with the employer's banking institution 134. A participating employer sets up a funding account, i.e., an employer Custody Account 136 at a bank or other financial institution that will be used to fund covered dental care services. The custody account 136 includes accounting features that track expenditures by specific beneficiaries. Participating employers also set up accounts for participating employees/beneficiaries 137, or prompt their employees to set up such accounts.

The administration function also facilitates the establishment of employer-related payment accounts for their employees through a legal documents module 133. The system facilitates the establishment, or linkage of an existing, employee Health Savings Account (HSA), Health Reimbursement Arrangement (HRA), Flexible Spending Account (FSA), or conventional bank account 137, which is shared with the enrollee's banking institution 135. The employee account 137 receives from the employer any funds allocated for dental care and may be at least partially funded by the employer's funding account.

The enrollee's account 137 and the employer's custody account 136 are linked to an employer Benefit Payment Tool 139, which manages certain financial aspects of dental services provision between employers and beneficiaries and includes the use of a Benefit Card 140. A Benefit Card 140 is a debit card or credit card that can be loaded with employer funds and debited for dental services rendered. Beneficiaries may pay from their employer's funding account by use of the Benefit Card 140, they may be required to pay for some dental services from their employee account 137, or they may need to pay out of pocket, e.g., if services fees exceed the enrollee's health benefit amount, or to cover a deductible, etc.

Within the Benefit Payment Tool 139, the system conducts an employer-centered accounting function 141 for the employer and associated beneficiaries in the system. When an employer's beneficiary loads or spends money on their issued Benefits Card 140, the accounting function 141 tracks the Benefit Card activity in a module 142. The Benefit Card activity for each beneficiary is traced back to the employer's bank 143, and dental services fees from practitioners and payments are reconciled 144. With the custody account 136 and Benefit Payment Tool 139 in place, the system links payment authorizations to Know Your Customer (KYC), anti-money laundering (AML), and other transaction protection/monitoring functions 138.

The administration function uses the employer custody accounts 136 and an employee account 137 for each of the employer's employees to manage dental services payments. The employer custody account 136 tracks employer-provided funds 146, which may be provided to an employee via the Benefit Card 140. Benefit Cards may be issued to employees when they interact 147 with the Matching Tool. When an employee uses the Matching Tool, the system contacts the bank accounts linked to the employee and their employer 149. If the employee is a new patient, using the Matching Tool triggers the system to send a thank you message to the practitioner 152. The employee account 137 tracks payroll funding 162, which may be loaded onto a Benefit Card 140, and used to pay for dental services rendered 160.

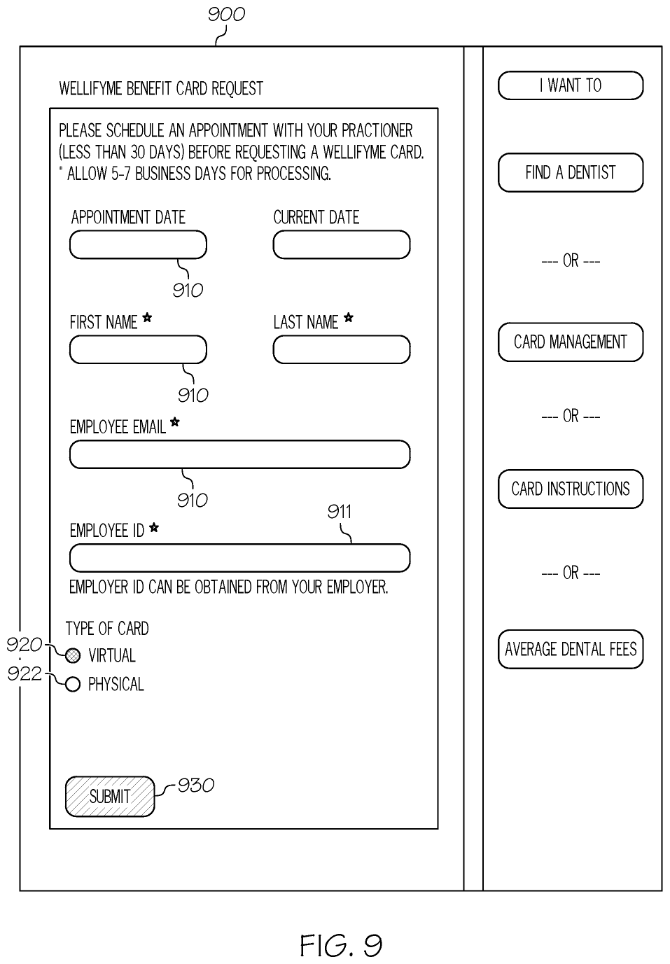

The Benefit Card 140 is a means for direct payment for dental care services, and may be, e.g., a debit card, a pre-loaded credit card, an account number, scannable code displayed on a smartphone, etc. An employer may fund a Benefit Card and provide it to their beneficiary for a particular dentist visit, or the Benefit Card may be funded for a beneficiary's use over an IOP coverage period, or other suitable amount or time period. The Benefit Card improves on previous methods of payment for dental care services by allowing the direct and transparent funding for dental services rendered as paid by the employer to a dental services provider. In some embodiments, the Benefit Card is tied to a specific dental care appointment for a beneficiary. In such embodiments, the beneficiary schedules an appointment with a dental care provider, then visits a web portal configured to take requests for a Benefit Card. The beneficiary fills out and submits an online request form, see FIG. 9. The request form is processed by the benefit provider, then the Benefit Card is loaded with a certain dollar amount from the employer's account and is issued to the beneficiary. The beneficiary may choose whether to receive a physical card, or a virtual card, which may be payment card details emailed or SMS messaged to an account held by the beneficiary. When the beneficiary pays for care using the Benefit Card, any balance remaining on the card returns to the employer's funding account, or if instead there remains a balance owed, the beneficiary will pay the excess amount to the dental care provider directly.

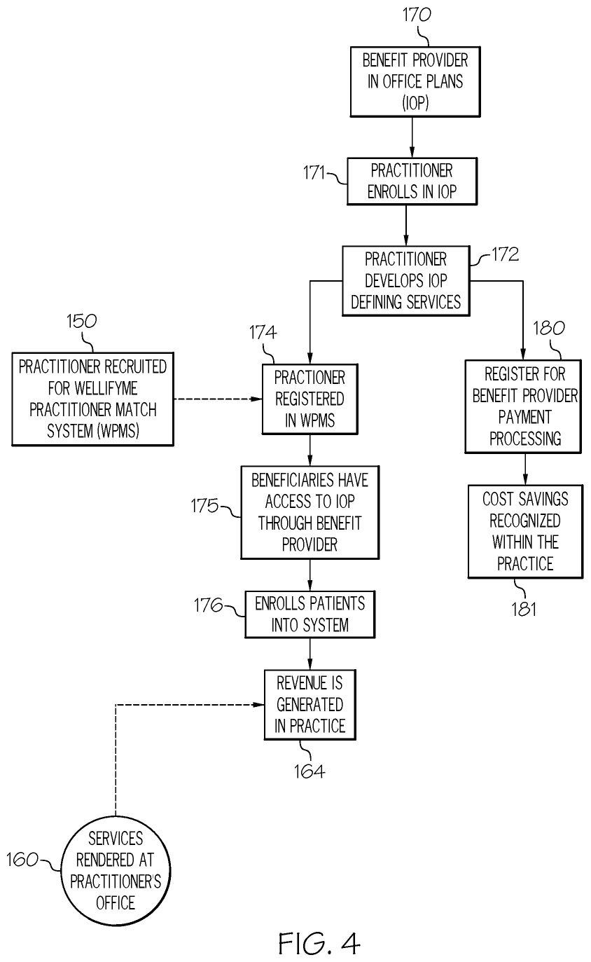

With reference to FIG. 4, which depicts a portion of the flow chart from FIGS. 1A and 1B, the In Office Plan (TOP) module 170 of the system is shown. The benefit provider administers a number of In Office Plans, which comprise customizable sets of in-office coverage options made available to employers for the provision of dental care benefits to their employees. IOPs may be organized as known in the art of the provision of health care services, such as by maximum annual spend per enrollee, numbers of enrollees, subsets of dental procedures covered, participation of family members, enrollee risk factors, or other suitable criteria. Employers, beneficiaries, and practitioners may choose to participate in an IOP. Employers participating in the provision of dental care services through the disclosed system may choose to enroll its employees in one or more IOPs. Beneficiaries may enroll in an IOP through their employer, or may enroll in an IOP directly through the Matching Tool. For example, an employer may offer its employees enrollment in an IOP and purchase a number of slots in the IOP for that year, at which point their employees could enroll in the offered plan. Alternatively, the employer may instruct their employees to go onto the Matching Tool, select a practitioner offering an IOP, and provide the employee funds to purchase a slot in the IOP for the year. A practitioner may register to participate in one or more IOPs 171 through the system website or application. Once a practitioner agrees to participate in an IOP, the practitioner works with the benefit provider, e.g., by accessing the system website or application, to define which dental services it will offer under the plan, IOPs the provider selects for participation, dental care services offered, dentist information, pricing information, location, consent to adhere to IOP rules, or other suitable information 172. Providers that join an IOP also register 174 for participation in the Matching Tool, e.g., by claiming and verifying the information in an existing listing for the dentist or dental practice, or by creating a listing for the dentist/dental practice.

When engaging with the disclosed system, beneficiaries use the Matching Tool, which identifies practitioners that participate in the beneficiaries' approved IOP 175, in this way, beneficiaries are provided access to practitioners in their IOP through the disclosed system. Once the beneficiary selects a practitioner, the practitioner enrolls the beneficiary 176 in the internal systems administered by the practitioner, and the beneficiary becomes a patient of the dentist or dental practice. The dentist provides services to the patient 160, which generates revenue for the dentist's practice 164.

Embodiments of the disclosed system also allow practitioners that participate in one or more IOPs to register for the Payment Processing Tool 180 through the benefit provider, resulting in additional cost savings 181 through more efficient payment administration. The Payment Processing Tool 180 provides point-of-sale payment processing to reduce processing cost for providers, and to streamline the administration of IOPs. Providers that participate in an IOP, or, in some embodiments, that are featured on the Matching Tool, may elect to register with the Payment Processing Tool to facilitate affected transactions. The Payment Processing Tool may be configured to work with the Benefit Card for enrollees in an employer's TOP. Practitioners may also be recruited 150 to join the system and register 174 for a listing in the Matching Tool without being a part of an IOP.

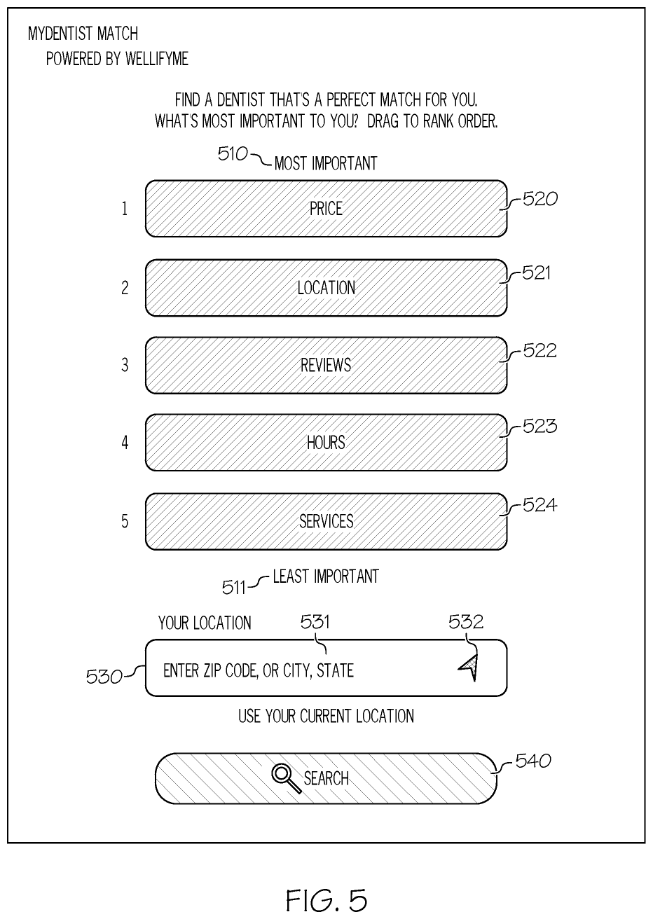

In some embodiments, enrollees may prioritize the various criteria when searching for providers. For example, a beneficiary goes onto the Matching Tool application, and is presented with a number of criteria to guide the matching process. With reference to FIG. 5, a graphical user interface is depicted, the interface showing a criteria list configured to allow a beneficiary to initiate a search for dental care providers. The application presents a default ranking of criteria, e.g., listed from most important 510 at the top to least important 511 at the bottom. These criteria include, for example: 1) price 520, 2) location 521, 3) average customer review 522, 4) hours of operation 523, and 5) services offered 524. In some embodiments, the application may also provide a default range for each criterion, e.g., a desirable price range, a desirable range of distances from the beneficiary's residence, etc. The beneficiary can choose to elevate location to the highest rank, and customer reviews to third, so that the beneficiary's ranking becomes as follows: 1) location, 2) price, 3) average customer review, 4) services offered, 5) hours of operation. The beneficiary may also adjust the default ranges for one or more criteria, e.g., lowering the maximum price for a cleaning visit, or choosing to see only those dental practices with four-star or better reviews. To receive tailored results for a geographic location, the beneficiary enters location information into the location window 530. The beneficiary can either enter the area to be searched 531, i.e., a city and state or a zip code, or can activate the current location icon 532 to use the local information accessible to the application. The enrollee initiates the search by clicking the Search button 540, and the application generates a list of dental care providers, rank ordered by percent (%) match with the customer's criteria ranking, i.e., % Match score. The application determines the % Match score based on the dental practices' correspondence to the range preferences for each criterion, weighted based on the importance of the criteria in the ranking order. The application then presents a list of dental practices in order of each practice's % Match score.

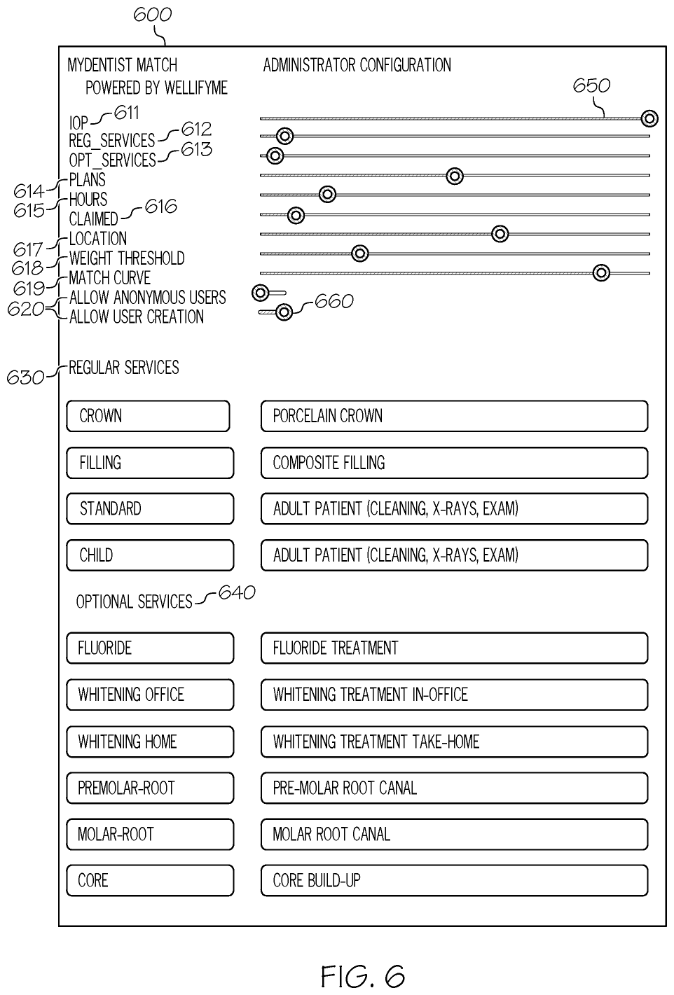

With reference to FIG. 6, in some embodiments, an administrator of the system may adjust settings for the Matching Tool through an administrator configuration screen 600. The configuration screen 600 allows the benefit provider, e.g., WellifyME, Inc. to optimize settings across the system to provide the most useful results for beneficiaries and practitioners. The configuration screen includes a number of categories 611, 612, 613, 614, 615, 616, 617, 618, 619 that can be adjusted by use of a weighting slider 650, and other categories 620 that can be activated or deactivated via radio buttons 660. The weighted categories can be given more or less weight, i.e., importance, in the Matching Tool algorithm by adjusting the sliders 650 to the left for less weight or to the right for increased weight. The weighted categories include whether a practitioner is a participant in an IOP 611, whether the practitioner offers certain regular services 612 or optional services 613. Regular services may be specified by inputting the services into the regular services listing 630, and optional services can be specified by adding the services to the optional services listing 640. The services included in either category may be adjusted based on trends in dental care services. The Matching Tool assesses the practitioner's service offerings in relation to the inputted regular 630 and optional 640 services, and provides a score for the practitioner, which may then be refined by adjusting the corresponding sliders. Other weighted categories include whether the practitioner offers other savings plans 614 for services aside from an IOP, what hours the practitioner offers services 615, whether the practitioner has claimed their listing entry in the system 616, and the location of the practice 617. The weight threshold 618 is a category that can be adjusted to remove practitioners with a low % Match score from the displayed results. Finally, the Match Curve 619 is a category that allows a user to boost or lower % Match scores depending on the practitioner market. For example, if practitioners are achieving a maximum % Match score of 50%, this score can be boosted so that the maximum % Match score is displayed as 90%. Or if all practitioners score above 90% for their % Match score, the slider can be moved left to allow beneficiaries to see more distinction between search results. The configuration page 600 also gives users the option to allow anonymous users in the system, and to allow or disallow the creation of new users in the system 620.

With reference to FIG. 7A, a standard listing of search results output by the Matching Tool is depicted as a graphical user input display. The search results include dental care providers ranked according to each provider's % Match score. The results display 700a may include a compact Matching Tool interface 710. The compact search interface 710 includes a button for setting the user's category weighting preferences 711, a button for setting the search location 712, and a search button 713 for initiating the search. The results page 700a also includes entries 720a, 721, 722, 723 for dentists or dental practices ranked based on their % Match score 730. The displayed entries may either be expanded 720a as indicated by a caret button 740 oriented toward the top of the page, or compact 721, as indicted by a caret button oriented toward the bottom of the page 741. The caret button can be clicked or tapped to alternately expand or compact the entry display. All entries display basic information, such as the name of the dentist or dental practice, their % Match score 730, and whether the entry is a regular listing 744 generated by the Matching Tool, or a sponsored listing. Also listed is a Savings Available status indicator 742, which highlights entries that offer savings programs to customers, such as an TOP, a senior discount, a new patient discount, an open seat discount, etc. Some embodiments may list the type of savings program on the display (not shown). If no savings are available, an appropriate indicator 743 is displayed. Expanded entries 720a may also include contact information 762 for the practitioner, a photo or map of the office's location 760, a description of the dental practice 761, as well as buttons for requesting an appointment 750, exploring cost saving options 751, and a summary of regional price guidance for dental services 752, see FIG. 2, 116. In some embodiments, an average customer review (not shown) is also displayed.

Search results may also be displayed on a mobile computer interface, such as a smartphone or tablet, as depicted by FIGS. 7B and 7C. As with the standard display, the mobile display 700b may include a compact search interface 710b, and ranked entries for dentists or dental practices 724, 725, 726. The mobile display 700b may also include compact entries, as indicated by the caret buttons 741. With reference to FIG. 7C, the mobile display 700c is in expanded mode as indicated by the caret button 740. In expanded mode, the mobile display no longer shows the compact search interface, and displays only one entry 727. The expanded entry 727 includes similar information as found in the expanded entries 720a of the standard display 700a. For example, pricing information 764 is shown. In some embodiments, regional price guidance, see FIG. 2, 116, is accessed by clicking the pricing information 764 to display a comparison of the practitioner's offered prices to regional averages. Like the standard display, the mobile display may include an average customer rating 745. Some may display more comprehensive information about particular practices based on certain criteria, e.g., the first five ranked practices, practices that pay sponsor fees, or practices the beneficiary selects. The beneficiary then can review the generated list and choose a dental care provider.

For practitioners, the Matching Tool includes business marketing and competitive positioning opportunities. In some embodiments, dental practitioners may enter pricing information into the application, allowing providers to adjust prices based on availability, capacity, or other suitable criteria. For example, a dental practice may have excess capacity in its offices, or a particular dentist may have excess capacity, both as measured by unfilled appointment slots, i.e., open chair times. In response, the dental practice can choose to reduce fee listings in the Matching Tool, or can offer an open chair discount, which will typically result in an improved % Match score for patients. When beneficiaries search for a dentist on the Matching Tool, the dental practice in question will emerge higher in beneficiaries' results listings than it otherwise would, causing more beneficiaries to select the dental practice, and thus allowing the dental practice to reduce its open chair time.

In another embodiment, the Matching Tool may include the ability for beneficiaries to make an offer for care, and providers could choose to accept the offer or propose a counteroffer. Beneficiaries may seek to pay an alternative amount based on personal criteria, e.g., an amount the beneficiary previously paid for the same procedure, an amount sought by another dental care provider for the same procedure, an amount based on the beneficiary's ability to pay, an amount based on the beneficiary's overall outlay for the year, or other personal criteria. Dental care providers may opt out of the offer feature based on business preferences, or may be required to do so by, e.g., an TOP or insurance contractual requirements. The offer feature presents an opportunity for providers to negotiate pricing on an individual patient level without disclosing the reduced pricing publicly.

Embodiments of the disclosed system also include a Patient Lending Tool, comprising a micro-financing system to allow beneficiaries to reduce their out-of-pocket expense for dental procedures, and allowing options for the payment of dental bills over time.

With reference to FIG. 8, a dentist referral form 800 is depicted. The referral form contains two categories of information, information about the referred dentist or dental practice, and information about the person or organization referring the practitioner to the system. The form includes fields for the entry of the dentist's name 810, the dental practice name 811, and contact information for the practitioner 812. The person referring the practitioner enters their contact information 820, their name 822, and any comments 824, including their reasons for the referral. Other relevant information may also be sought as appropriate. Referrals are accomplished by any user of the system, including employers, beneficiaries, or other practitioners. Once the information is input by a user, they submit the information by activating the submit button 830.

With reference to FIG. 9, a Benefit Card request form 900 is depicted. An enrollee of the system can use the request for to receive a Benefit Card that will be loaded with funds to pay for dental services. The enrollee fills in the requested information in the provided entry fields 910, and chooses whether to receive a virtual card 920 or a physical card 922. The Figure shows a virtual card has been selected. In some embodiments, the enrollee must enter their employer's identification number 911, which is, e.g., a US federal tax identification number, an internal code generated by the system for the employer, or other suitable code to allow verified access to the employer's funds. Once the form is filled in, the enrollee provides the information to the system by selecting the submit button 930.

Embodiments of the disclosed invention provide a number of benefits to beneficiaries and their employers, as well as to dental care providers. Employers and employees benefit through comprehensive patient-provider matching, which improves patient satisfaction; increased price transparency, which allows improved insight into benefit expenditures; the development of an efficient marketplace for care, which functions to reduce costs and stretch benefit dollars; ease of appointment scheduling and payment, which improves efficiency; benefit payment card, which increases transaction efficiency and reduces cost; finally, beneficiaries can make an offer to pay a lower rate for care. Dental practices benefit through increased control over pricing, which allows active marketing, the ability to reduce open chair times by offering discounts, and the ability to adjust patient ranking scores. Accepting patient offers for care allows practices to privately negotiate rates with patients when desired. Participation in a more transparent marketplace allows dental practices to discover weaknesses in their pricing schemes, service offerings, etc., in order to improve their competitiveness with other practices.

Although several processes have been disclosed herein as software, it may be appreciated by one of skill in the art that the same processes, functions, etc. may be performed via hardware or a combination of hardware and software. Similarly, although the present invention has been depicted as a wireless system, these concepts may be applied to hardwired systems and hybrid hardwired and wireless systems without departing from the scope of the present invention.

As will be understood by those familiar with the art, the disclosed invention may be embodied in other specific forms without departing from the spirit or essential characteristics thereof. Likewise, the particular naming and division of the modules, managers, functions, systems, layers, features, attributes, methodologies, and other aspects are not mandatory or significant, and the mechanisms that implement the invention or its features may have different names, divisions, and/or formats. Accordingly, the disclosure of the present invention is intended to be illustrative, but not limiting, of the scope of the invention.

While this invention has been described in terms of several embodiments, there are alterations, modifications, permutations, and substitute equivalents, which fall within the scope of this invention. Although subsection titles have been provided to aid in the description of the invention, these titles are merely illustrative and are not intended to limit the scope of the present invention. In addition, where claim limitations have been identified, for example, by a numeral or letter, they are not intended to imply any specific sequence. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention

This has been a description of the disclosed invention along with a preferred method of practicing the invention, however the invention should be defined by the appended claims.

What is claimed is:

1. A method for providing dental care benefits to a beneficiary, the method comprising:
displaying a list in response to a search, wherein the list includes one or more providers of dental services, wherein the list is ordered by a percent (%) match score, and wherein the % match score is a measure of correspondence between each of the one or more providers and a set of search criteria.

2. The method of claim 1, wherein the set of search criteria includes the following categories for each of the one or more providers: a set of price information for dental services, a location, a customer review average, a set of operating hours, and a list of dental services offered.

3. The method of claim 2, wherein the categories are weighted by one or more of the following: an algorithm, a relative importance of each category to the beneficiary, an administrator weighting function.

4. The method of claim 1, further comprising:
offering to the beneficiary one or more plans for dental services, each of the one or more plans comprising one or more participating employers, one or more participating providers, and a set of dental services offered.

5. The method of claim 1, further comprising:
administering payments for dental services, comprising registering one or more employers, registering one or more beneficiaries, establishing an employer account for each of the one or more employers, establishing a beneficiary account for each of the one or more beneficiaries, and establishing an employer payment mechanism for each of the one or more employers, wherein each of the one or more beneficiaries is associated with an employer.

6. The method of claim 5, wherein each beneficiary account is linked to one or more of the following: a bank account, a Health Savings Account, a Health Reimbursement Arrangement, a Flexible Spending Account, an employer payment mechanism, and a benefit card.

7. The method of claim 5, wherein each employer account is linked to one or more of the following: one or more beneficiary accounts, a bank account of the employer, an employer payment mechanism, and a benefit card.

8. The method of claim 5, wherein each employer payment mechanism comprises the following: a transaction protection function, an accounting function, a benefit card usage tracking function, and a fee for service tracking function.

9. The method of claim 1, wherein the set of search criteria further includes a plan membership status, a sponsorship status, and a claimed entry status.

10. A system for providing dental care benefits, the system comprising:
a computer configured to perform a search for providers of dental services, the computer comprising a processor, processor associated memory, a user interface, and data storage, and wherein the processor, memory, interface, and data storage are configured to run an application on the computer for the search, wherein the application is configured to exchange information with a user via interaction with the interface, the application controlling the interface by presenting outputs on a display and reading data from the interface in relation to the outputs;
a plurality of entries accessible to the application, each of the plurality of entries containing information about a provider of dental services, wherein the information includes one or more of the following: a name of the provider, a location of the provider, a list of dental services offered, a list of price information for dental services, a list of operating hours, and a list of contact information; and
an administration module, comprising a registration function, an employer account function, and an employee account function;
wherein the application is configured to perform the following:
collect a set of criteria from a user,
perform a search of the plurality of entries and display one or more entries based on a correlation between the entry and the set of criteria, and
perform one or more administrative functions when the user selects provider.

11. The system for providing dental care benefits of claim 10, wherein the information further includes one or more of the following: a membership status in an In Office Plan, a senior discount program, a new patient discount program, and an open chair discount program.

12. The system for providing dental care benefits of claim 10, wherein the registration function includes one or more of the following: collecting information about an employer, creating an employer custody account, creating an employer benefit payment tool, and creating one or more employee accounts.

13. The system for providing dental care benefits of claim 10, wherein the employer account function includes a module to verify transactions, an accounting module configured to reconcile services fees and payments, and an employer benefits card module configured to track funds added to and debited from one or more benefit cards.

14. The system for providing dental care benefits of claim 10, wherein the employee account function includes a payment module configured to interact with an employer benefit payment tool, and an employee benefits card module configured to interact with an employer benefits card module.

15. The system for providing dental care benefits of claim 10, further comprising a dental plan module configured to enroll a provider in a dental plan, create a list of dental services offered, create a list of price information, and enroll the provider in a payments processing system.

16. The system for providing dental care benefits of claim 10, wherein the set of criteria includes the following values: a location of the user, a price range, a set of dental services, an average customer review, and a set of operating hours.

17. The system for providing dental care benefits of claim 16, wherein the user ranks each value ire the set from most important to least important.

18. The system for providing dental care benefits of claim 10, wherein the search is adjusted by an administrator module, configured to change a weight given a value in the set of search criteria, to remove entries receiving a low percent match score from the displayed results, and to adjust a percent match score for an entry.

19. The system for providing dental care benefits of claim 18, the administrator module further configured to add or remove a regular dental service and an optional dental service from the set of search criteria.
